(19) United States
(12) Patent Application Publication
(10) Pub. No.: US 2004/0123054 A1
(43) Pub. Date: Jun. 24, 2004

(54) Portable computing device having a non-volatile memory device adapted to detect when a current memory operation is to be suspended and method therefor

(76) Inventor: Geoffrey A. Gould, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/326,561

(22) Filed: Dec. 20, 2002

(51) Int. Cl. G06F 12/00; G06F 12/14; G06F 12/16; G06F 13/00; G06F 13/28; G06F 13/24

(52) U.S. Cl. 711/154

(57) ABSTRACT

Briefly, in accordance with one embodiment of the invention, a portable communication device may include a processor coupled to a non-volatile memory device. The non-volatile device may be adapted to monitor system signals and determine if the non-volatile memory device should suspend a current operation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic representation of a portion of a portable communication device in accordance with an embodiment; and

FIG. 2, is a schematic illustrating addition detail of the embodiment illustrated in FIG. 1.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

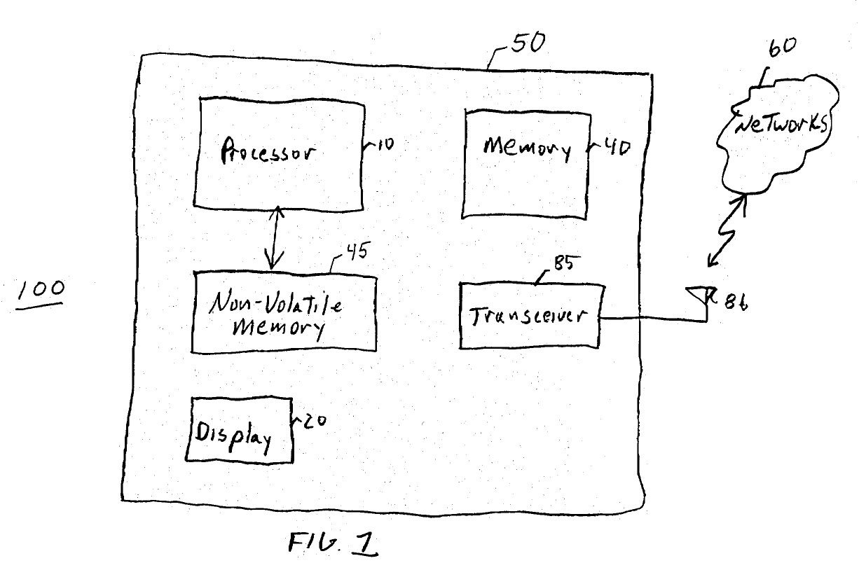

Turning to FIG. 1, an embodiment 100 in accordance with the present invention is described. Embodiment 100 may comprise a portable computing or communication device 50 such as a mobile communication device (e.g., cell phone), a two-way radio communication system, a one-way pager, a two-way pager, a personal communication system (PCS), a personal digital assistant (PDA), a portable computer, or the like. Other embodiments may include, for example, any combination of laptop and portable commuters with wireless communication capability, web tablets, wireless headsets, instant messaging devices, MP3 players, digital cameras, and other devices that may receive and/or transmit information wirelessly. However, it should be understood that the scope and application of the present invention is in no way limited to these examples. Other embodiments of the present invention may include other computing systems that may or may not be portable or even involve communication systems such as, for example, desktop or portable computers, servers, network switching equipment, etc.

In this particular embodiment, portable computing device 50 may include a processor 10 that may execute instructions. Processor 10 may be one of a variety of integrated circuits such as, for example, a microprocessor, a central processing unit (CPU), a digital signal processor, a microcontroller, a reduced instruction set computer (RISC), a complex instruction set computer (CISC), or the like, although the scope of the present invention is not limited by the particular design or functionality performed by processor 10. In addition, in some alternative embodiments, portable computing device 50 may comprise multiple processors that may be of the same or different type.

Portable communication device 50 may also comprise volatile memory 40 and a non-volatile memory device 45 that may be used to store data and/or instructions for processor 10, although the scope of the present invention is not limited in this respect. In some embodiments, memories 40 and 45 may be used to store sets of instructions such as instructions associated with an application program, an operating system program, a communication protocol program, etc. For example, the instructions stored in memories 40 and 45 may be used to perform wireless communications, provide security functionality for portable communication device 50, user functionality such as calendaring, email, internet browsing, etc.

Although the scope of the present invention is not limited in this respect, non-volatile memory 45 may comprise a memory type such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, flash memory, or any other type of media suitable for storing electronic data and/or instructions, and capable of being coupled to a system bus for a computing device.

Portable communication device 50 may also comprise a display 20 to provide information to a user and a transceiver 85 to provide access to other devices, service, networks, etc that may be used to allow portable communication device 50 to communicate with other networks through either a wired or wireless link. As shown, transceiver 85 may use antennae 86 to wirelessly communicate with networks 60.

Although the scope of the present invention is not limited in this respect, communication transceiver 85 may employ a variety of wireless communication protocols such as cellular (e.g. Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like). In addition, portable communication device 50 may also include multiple transceivers that use different communication protocols.

In addition, transceiver 85 may use other protocols such as wireless local area network (WLAN), wide area network (WAN), or local area network (LAN) protocols such as the Industrial Electrical and Electronics Engineers (IEEE) 802.11 standard, Bluetooth™, infrared, etc. (Bluetooth is a registered trademark of the Bluetooth Special Interest Group).

It should be understood that the scope of the present invention is not limited by the types of, the number of, or the frequency of the communication protocols that may be used by portable communication device 50. Furthermore, alternative embodiments may have more than two communication modules (either wired or wireless) and communication modules need not have separate antennae, and some or all may share a common antenna.

It should also be understood that portable communication device 50 may include other optional components such as, for example, a vocoder to encode voice data, etc.

Alternatively or in addition, portable communication device 50 may include other components such as input/output devices, audio outputs, etc. However it should be understood that the scope of the present invention is not limited so as to require any particular combination of components shown in FIG. 1. It should also be understood that the components shown in FIG. 1 need not be discrete or separate components. In alternative embodiments, some of the components shown may be integrated together.

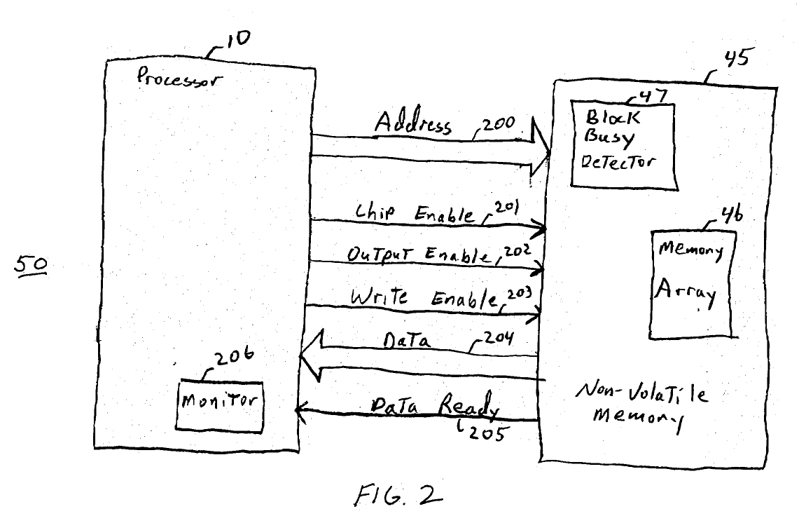

Turning now to FIG. 2, a particular embodiment of the present invention is described. FIG. 2 is a block diagram illustrating some of the signals that may be used to interact between processor 10 and non-volatile memory 45. In this particular embodiment non-volatile memory 45 may include a memory array 46 comprising flash memory cells (either single-bit or multi-bit per cell). In addition, memory array 46 may be organized in blocks of the same or varying sizes, although is should be understood that the scope of the present invention is not limited in these respects.

Non-volatile memory 45 may have the capability to interrupt or halt an operation that may be occurring with one block to permit an operation on the same or another block in memory array 46. For example, non-volatile memory device 45 may be able to halt the programming or erasing of one block of memory array 46 to permit the reading of another block. Alternatively, non-volatile memory device 45 may be able to interrupt the reading of one block to permit a read of another block. It should be understood that the scope of the present invention is not limited by the particular operation that may be halted or by the alternative operation that may be performed once the current operation is halted.

In this particular embodiment, non-volatile memory device 45 is adapted to monitor signals from processor 10 so that non-volatile memory device 45 may determine for itself if an operation currently being performed should be interrupted or halted. In this particular embodiment, non-volatile memory device 45 may monitor signals that are originated or generated directly from processor 10. However, in alternative embodiments it should be understood that non-volatile memory device 45 may monitor additional or alternative signals.

For example, non-volatile memory 45 may monitor signals being transmitted over a bus within portable communication device 50. Alternatively, non-volatile memory 45 may monitor signals coming from other components within portable communication device 50 such as, for example, input/output (I/O) devices, direct memory access (DMA) engines, caches, other memory devices, user input signals, etc. Thus, the scope of the present invention is not limited the type, number, source, or nature of the signals that are monitored to determine if an operation that is currently being performed, or that is scheduled/queued up to be performed, should be interrupted, suspended, or stopped altogether. In addition, an explicit request to suspend or halt an operation need not come directly from or be initiated by the processor.

In this particular embodiment, non-volatile memory device 45 may monitor at least a portion of the address signals 200 that are used by processor 10 to indicate the location of the information desired. Although the scope of the present invention is not limited in this respect, the address signals may be generated by processor 10 or by other components such as a cache controller, a DMA engine, etc.

Additionally or alternatively, non-volatile memory device 45 may monitor other signals such as, but not limited to, a chip enable signal 201 to indicate the desired operation is intended for non-volatile memory device 45, an output enable signal 202 to indicate if and/or when non-volatile memory device 45 should provide data, a write enable signal 203 to indicate if processor intends to read data or write data, a reset signal (not shown) to indicate when portable communication device 50 is in a reset condition, etc. It should be understood that in alternative embodiments non-volatile memory device 45 may monitor any combination of signals available within portable communication device 50 to determine when an operation should be interrupted or halted. It should be understood that the scope of the present invention is not limited to embodiments where signals 200-203 are active-high or active-low as any combination thereof may be used.

Although the scope of the present invention is not limited in this respect, non-volatile memory device 45 may comprise a block busy detector 47 to determine if the address 200 provided by a processor refers to a block involved in the current operation. For example, block detector 47 may compare all or a portion of address signals 200 to determine if the address refers to data that is within a block of memory array 46 that is involved the current or queued operation (e.g. the block is being programmed, erased, written to, read from, etc.). Thus, block busy detector 47 may provide a logical signal that may be used to indicate, at least in part, if the address 200 supplied by processor 10 would interfere with an operation that may be occurring in non-volatile memory 45.

Non-volatile memory device 45 may also compare the output of block busy detector 47 with other signals (e.g. chip enable signal 201, output enable signal 202, write enable signal 203, etc.) to determine if the current operation should be suspended. This determination may be accomplished by combinatorial logic whose output is intended to indicate when the current operation occurring, or one that may be about to occur, should be interrupted to allow another operation to be performed.

Although the scope of the present invention is not limited in this respect, non-volatile device 45 may take the appropriate steps to halt the current operation. For example, non-volatile memory 45 may stop programming or erasing and return non-volatile memory device to a normal operating condition, reset latches and sense-amps, etc. Non-volatile memory device 45 may also save the appropriate information or the state of non-volatile memory 45 so that it may be able to resume the operation being halted at a later time.

Non-volatile memory device 45 may also optionally send an acknowledge signal to processor 10 to indicate that it has recognized that is should suspend the current operation. In other words, non-volatile memory device 45 may indicate that it is currently busy, but is in the process of making arrangements to execute an operation requested by processor 10. This information may be used by a monitor 206 in processor 10 to predict or schedule when the requested information will be available. Although the scope of the present invention is not limited in this respect, monitor 206 may be any combination of hardware and software and used in conjunction with devices such as caches, instruction pipelines, etc. in processor 10. The use of monitor 206 should be considered optional.

After halting the current operation, non-volatile memory device 45 may then perform the operation requested by processor 10. For example, non-volatile device may access the information referred to by address signals 200 and provide the data to processor 10. Non-volatile memory device 45 may assert or provide a data ready signal 205 to processor 10 to indicate that the requested data is available with data signals 204 or that non-volatile memory device 45 is prepared to provide the data. Alternatively, non-volatile memory device 45 may perform other operations such as programming, erasing, changing the operational state of non-volatile memory device 45, changing a security state of non-volatile memory device 45, etc.

Although the scope of the present invention is not limited in this respect, after non-volatile memory device 45 has performed the operation requested (e.g. provided the data associated with address signals 200), non-volatile memory device 45 may return itself to the state it was in when it halted the interrupted operation and resume that operation. One advantage of this particular embodiment, although not necessarily all, is that the design or operation of processor 10 and/or portable communication device 50 may be simplified since non-volatile memory device 45 can determine for itself if is busy and if it should interrupt the current operation. Thus, processor 10 need not be encumbered with the overhead associated with having to track and determine if non-volatile memory device is busy and/or if it can and should be interrupted.

While certain features of the invention have been illustrated and described herein, many modifications, substitutions, changes, and equivalents will now occur to those skilled in the art. For example, the scope of the present invention is not limited to applications where processors are attempting to access memory devices that may have both slow and fast operations. Alternative embodiments may include applications having a master and slave device.

For example, the scope of the present invention includes applications where a slave is able to detect and or halt a current operation without the master device knowing that the slave device was busy. This may be done by having the slave device monitor signals from the master device so that it can determine when it should halt a current operation. Such embodiments may include, but are not limited to applications involving a disk-drive, a cache, I/O device, etc. It is, therefore, to be understood that the appended claims are intended to cover all such modifications and changes as fall within the true spirit of the invention.

1. A portable communication device comprising:
a processor;
a transceiver coupled to the processor; and
a non-volatile memory device coupled to the processor, wherein the non-volatile memory device is adapted to monitor signals from the processor to determine when a first operation of the non-volatile memory device should be interrupted to perform a second operation.

2. The portable communication device of claim 1, wherein the non-volatile memory device is further adapted to monitor signals from the processor to determine when the first operation of the non-volatile memory device should be interrupted to perform the second operation that is requested by the processor.

3. The portable communication device of claim 1, wherein the non-volatile memory device is adapted to monitor at least a portion of an address provided by the processor.

4. The portable communication device of claim 1, wherein the non-volatile memory device is further adapted to provide an acknowledge signal to the processor to indicate that the non-volatile memory device is in the process of interrupting the first operation.

5. The portable communication device of claim 1, wherein the non-volatile memory device is further adapted to provide a data ready signal to the processor to indicate that the non-volatile memory device is prepared to provide data as part of the second operation.

6. The portable communication device of claim 1, wherein the non-volatile memory device is further adapted to monitor signals from the processor to determine when an erase or program operation of the non-volatile memory device should be interrupted to perform a read operation.

7. The portable communication device of claim 1, wherein the non-volatile memory device is adapted to monitor a chip enable signal provided by the processor.

8. The portable communication device of claim 3, wherein the non-volatile memory array is adapted to determine if the address provided by the processor refers to a block of the non-volatile memory that is being accessed during the first operation.

9. The portable communication device of claim 1, wherein the non-volatile memory device comprises flash memory cells.

10. A method of interrupting a current operation of a non-volatile memory device, comprising:
monitoring input signals that are received by the non-volatile memory device to determine if the current operation of the non-volatile memory device should be halted.

11. The method of claim 10, further comprising monitoring a chip enable signal generated by a processor with the non-volatile memory device.

12. The method of claim 10, further comprising, determining if the input signals comprise an address that refers to a block in the non-volatile memory device involved with the current operation.

13. The method of claim 12, wherein the current operation includes erasing the block in the non-volatile memory device.

14. The method of claim 10, further comprising reading at least a portion of the non-volatile memory device after halting the current operation.

15. The method of claim 14, further comprising providing a data ready signal with the non-volatile memory device.

16. A method comprising:
halting a current operation in a slave device without the knowledge of a master device that the slave device is currently busy.

17. The method of claim 16, further comprising monitoring output signals of the master device with the slave device so that the slave device can determine that the slave device should halt a current operation.

18. The method of claim 16, further comprising halting the current operation and generating an acknowledge signal with the slave device.

19. The method of claim 18, wherein generating an acknowledge signal includes generating a data ready signal to indicate that data requested by the master device is available.

20. The method of claim 16, further comprising monitoring address signals from the master device with the slave device.

21. The method of claim 20, wherein monitoring address signals with the slave device includes monitoring signals with a device selected from the group comprising a non-volatile memory device, a disk-drive, and a cache.

22. A non-volatile memory device wherein the non-volatile memory device is adapted to monitor signals and determine if the non-volatile memory device should suspend a current operation to perform another operation requested by the a processor.

23. The non-volatile memory device of claim 22, further comprising a block busy detector to determine if the signals refer to a block involved in the current operation.

24. The non-volatile memory device of claim 22, wherein the non-volatile memory device is further adapted to suspend the current operation and provide data associated with the signals address.

25. The non-volatile memory device of claim 24, wherein the non-volatile memory device is further adapted to provide an acknowledge signal to indicate the data requested by the processor is available.

26. The non-volatile memory device of claim 24, wherein the non-volatile memory device is further adapted to resume the current operation after providing the data associated with the signals.
